(19) United States
(12) Patent Application Publication
(10) Pub. No.: US 2017/0205640 A1
(43) Pub. Date: Jul. 20, 2017

(54) Illuminated Eyeglasses System

(71) Applicant: Josette Lucero, Santa Fe, NM (US)

(72) Inventor: Josette Lucero, Santa Fe, NM (US)

(21) Appl. No.: 14/997,617

(22) Filed: Jan. 18, 2016

(51) Int. Cl. G02C 11/00; G02C 11/04; G02C 5/14; G02C 11/02

(52) U.S. Cl. CPC G02C 11/10; G02C 11/02; G02C 11/04; G02C 5/14

(57) ABSTRACT

An illuminated eyeglasses system includes a pair of eyeglasses may be worn. The eyeglasses include a first arm and a second arm. A light emitting array is coupled to the eyeglasses and the light emitting array is visible. The light emitting array emits light in a selected pattern. Thus, the light emitting array enhances an ornamental appearance of the eyeglasses. An electronic device is provided and the electronic device stores an actuation program. The electronic device is in electrical communication with the light emitting array. Thus, the actuation program actuates the light emitting array to emit light in a selected one of the plurality of patterns.

### BACKGROUND OF THE DISCLOSURE

### Field of the Disclosure

The disclosure relates to eyeglasses devices and more particularly pertains to a new eyeglasses device for emitting light in a selected pattern.

### SUMMARY OF THE DISCLOSURE

An embodiment of the disclosure meets the needs presented above by generally comprising a pair of eyeglasses may be worn. The eyeglasses include a first arm and a second arm. A light emitting array is coupled to the eyeglasses and the light emitting array is visible. The light emitting array emits light in a selected pattern. Thus, the light emitting array enhances an ornamental appearance of the eyeglasses. An electronic device is provided and the electronic device stores an actuation program. The electronic device is in electrical communication with the light emitting array. Thus, the actuation program actuates the light emitting array to emit light in a selected one of the plurality of patterns.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a illuminated eyeglasses system according to an embodiment of the disclosure.

FIG. 2 is a right side view of an embodiment of the disclosure.

FIG. 3 is a front view of an embodiment of the disclosure.

FIG. 4 is a cross sectional view taken along line 4-4 f FIG. 3 of an embodiment of the disclosure.

FIG. 5 is a cross sectional view taken along line 5-5 of FIG. 4 of an embodiment of the disclosure.

FIG. 6 is a schematic view of an embodiment of the disclosure.

FIG. 7 is a perspective in-use view of an embodiment of the disclosure.

### DESCRIPTION OF THE PREFERRED EMBODIMENT

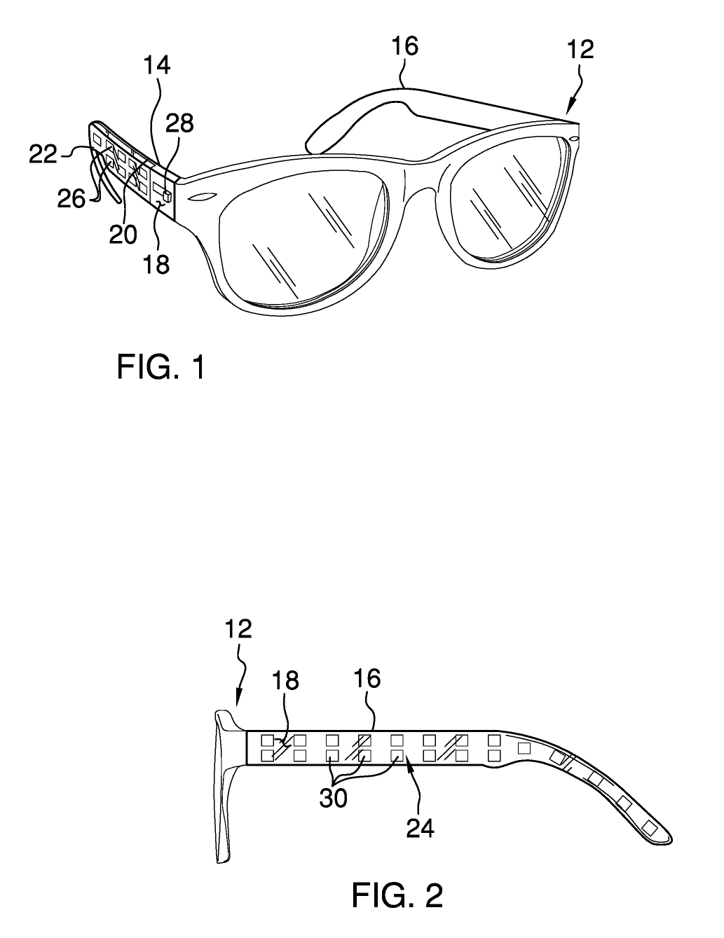

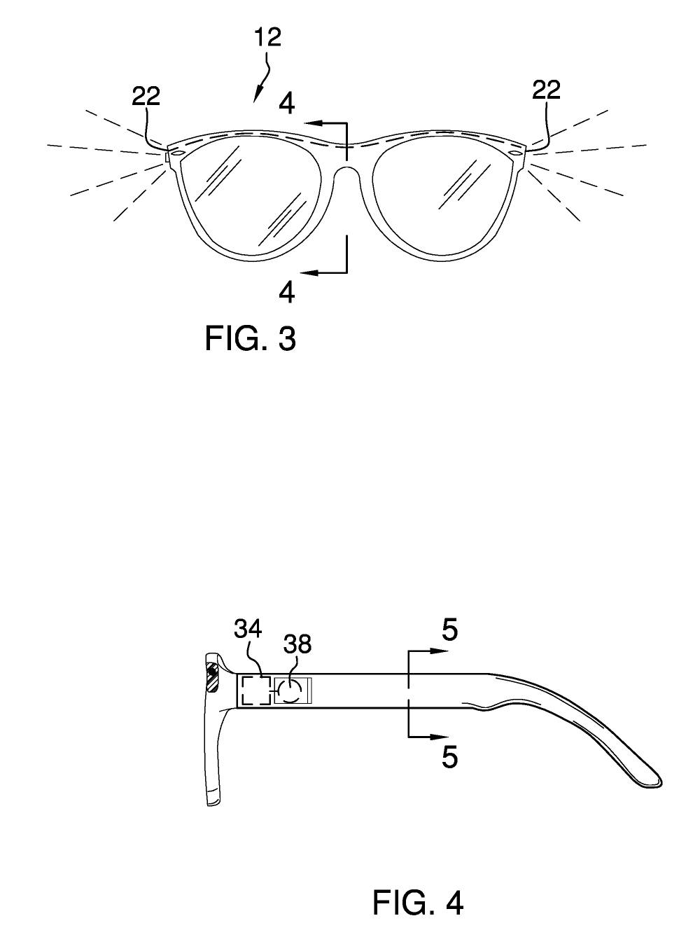

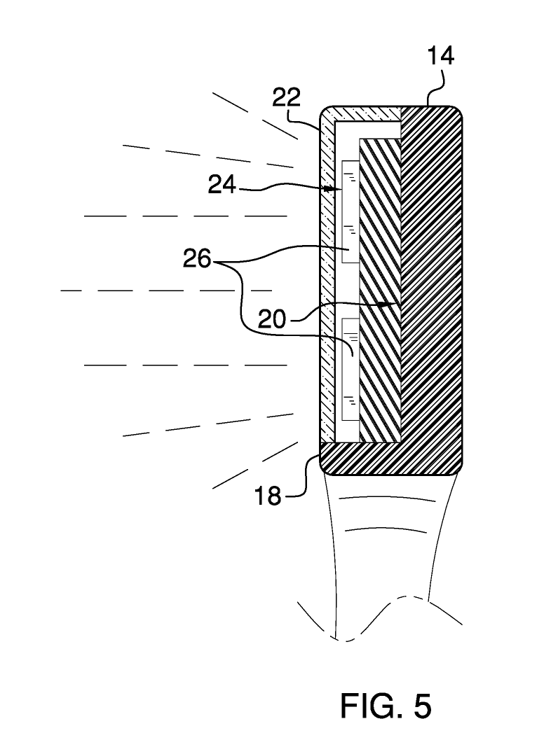

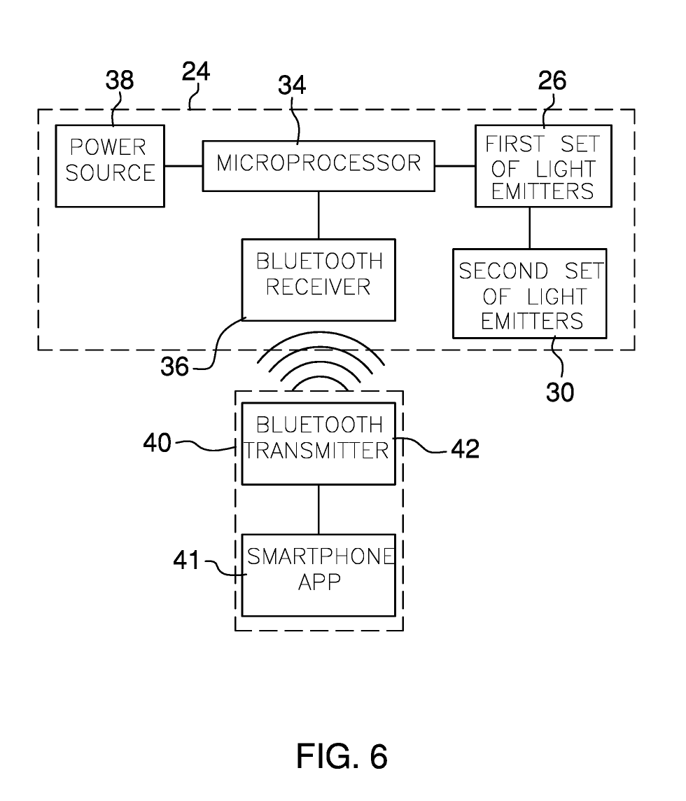

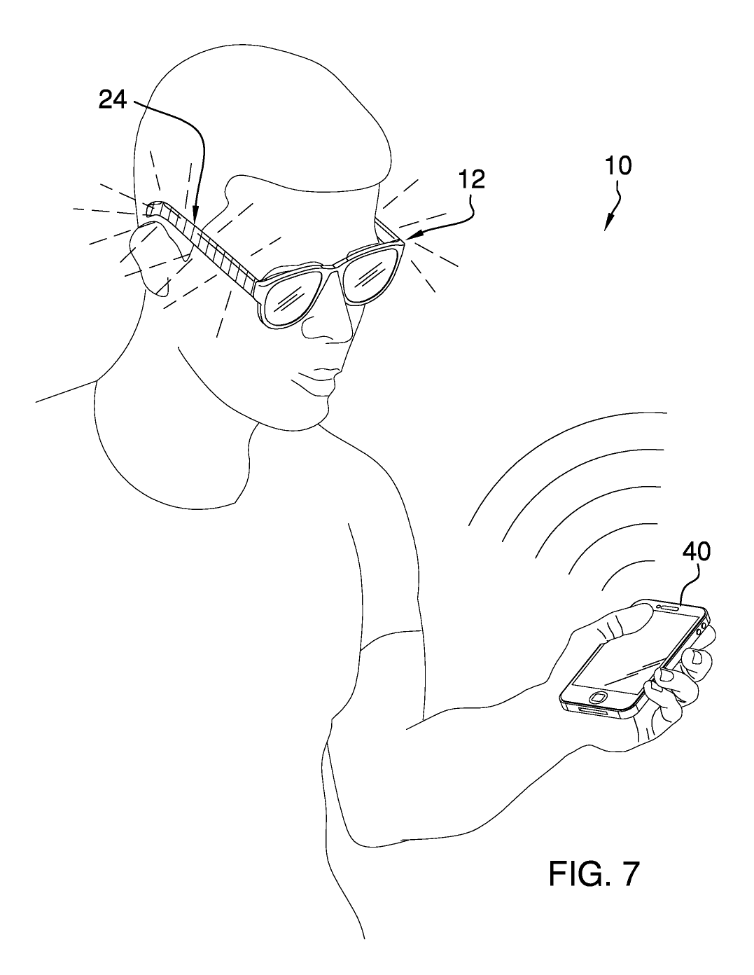

With reference now to the drawings, and in particular to FIGS. 1 through 7 thereof, a new eyeglasses device embodying the principles and concepts of an embodiment of the disclosure and generally designated by the reference numeral 10 will be described.

As best illustrated in FIGS. 1 through 7, the illuminated eyeglasses system 10 generally comprises a pair of eyeglasses 12 that may be worn. The eyeglasses 12 include a first arm 14 and a second arm 16. Each of the first arm 14 and the second arm 16 has an outwardly facing surface 18. The outwardly facing surface 18 of each of the first arm 14 and the second arm 16 has a recess 20 extending inwardly therein. The recess 20 corresponding to each of the first arm 14 and the second arm 16 extends substantially along the associated first arm 14 and the associated second arm 16. The eyeglasses 12 may comprise sunglasses, corrective eyeglasses or other eyeglasses.

A pair of covers 22 is provided. Each of the covers 22 is coupled to an associated one of the first arm 14 and the second arm 16. Each of the covers 22 is coextensive with the recess 20 corresponding to the first arm 14 and the second arm 16. Each of the covers 22 is comprised of a translucent material.

A light emitting array 24 is coupled to the eyeglasses 12. Thus, the light emitting array 24 is visible to an observer. The light emitting array 24 emits light in a selected pattern. Thus, the light emitting array 24 enhances an ornamental appearance of the eyeglasses 12.

The light emitting array 24 comprises a first set of light emitters 26. Each of the first set of light emitters 26 is positioned on the outwardly facing surface 18 of the first arm 14. The first set of light emitters 26 are spaced apart from each other and distributed along the recess 20 corresponding to the first arm 14. A first switch 28 is coupled to the outwardly facing surface 18 of the first arm 14 and the first switch 28 is electrically coupled to the first set of light emitters 26. Each of the first set of light emitters 26 may comprise an LED or the like and each of the first set of light emitters 26 may emit light in a plurality of colors.

A second set of light emitters 30 is provided. Each of the second set of light emitters 30 is positioned on the outwardly facing surface 18 of the second arm 16. The second set of light emitters 30 are spaced apart from each other and distributed along the recess 20 corresponding to the second arm 16. A second switch 32 is coupled to the outwardly facing surface 18 of the second arm 16 and the second switch 32 is electrically coupled to the second set of light emitters 30. Each of the second set of light emitters 30 may comprise an LED or the like and each of the second set of light emitters 30 may emit light in a plurality of colors.

A processor 34 is coupled to the eyeglasses 12. The processor 34 is electrically coupled to the first set of light emitters 26 and the second set of light emitters 30. The processor 34 actuates each of the first set of light emitters 26 and the second set of light emitters 30 to emit light in a selected one of a plurality of patterns. The processor 34 may comprise an electronic processor or the like.

A first transceiver 36 is coupled to the eyeglasses 12. The first transceiver 36 is electrically coupled to the processor 34. The first transceiver 36 may comprise a radio frequency transceiver or the like. A power supply 38 is coupled to the eyeglasses 12 and the power supply 38 is electrically coupled to the processor 34. The power supply 38 comprises at least one battery.

An electronic device 40 is provided and the electronic device 40 includes a second transceiver 42. The electronic device 40 stores an actuation program 41. The second transceiver 42 is in electrical communication with the first transceiver 36. The actuation program 41 actuates the first set of light emitters 26 and the second set of light emitters 30 to emit light in the selected one of the plurality of patterns. The electronic device 40 may comprise a smart phone or the like and the actuation program 41 may comprise a smart phone app or the like.

In use, the eyeglasses 12 are worn. The first switch 28 is manipulated to turn on the first set of light emitters 26. The second switch 32 is manipulated to turn on the second set of light emitters 30. The actuation program 41 is manipulated to select the pattern. Each of the first set of light emitters 26 and the second set of light emitters 30 emits light corresponding to the selected pattern.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated eyeglasses system comprising:
a pair of eyeglasses being configured to be worn, said eyeglasses including a first arm and a second arm;
a light emitting array being coupled to said eyeglasses wherein said light emitting array is configured to be visible on said eyeglasses, said light emitting array emitting light in a selected pattern; and
an electronic device, said electronic device storing an actuation program, said electronic device being in electrical communication with said light emitting array wherein the actuation program actuates said light emitting array to emit light in the selected one of the plurality of patterns;
wherein each of said first arm and said second arm has an outwardly facing surface, said outwardly facing surface of each of said first arm and said second arm having a recess extending inwardly therein, said recess corresponding to each of said first arm and said second arm extending substantially along a full length said associated first arm and said associated second arm; and
a pair of covers, each of said covers being coupled to an associated one of said first arm and said second arm, each of said covers being coextensive with said recess corresponding to said first arm and said second arm, each of said covers being comprised of a translucent material.

2. (canceled)

3. (canceled)

4. The system according to claim 1, wherein said light emitting array comprises:
a first set of light emitters, each of said first set of light emitters being positioned on said outwardly facing surface of said first arm, said first set of light emitters being spaced apart from each other and distributed along said recess corresponding to said first arm; and
a first switch being coupled to said outwardly facing surface of said first arm, said first switch being electrically coupled to said first set of light emitters.

5. The system according to claim 4, wherein said light emitter array comprises:
a second set of light emitters, each of said second set of light emitters being positioned on said outwardly facing surface of said second arm, said second set of light emitters being spaced apart from each other and distributed along said recess corresponding to said second arm; and
a second switch being coupled to said outwardly facing surface of said second arm, said second switch being electrically coupled to said second set of light emitters.

6. The system according to claim 1, wherein said light emitting array comprises:
a first set of light emitters;
a second set of light emitters; and
a processor being coupled to said eyeglasses, said processor being electrically coupled to said first set of light emitters and said second set of light emitters, said processor actuating each of said first set of light emitters and said second set of light emitters to emit light in a selected one of a plurality of patterns.

7. The system according to claim 6, further comprising a first transceiver being coupled to said eyeglasses, said first transceiver being electrically coupled to said processor.

8. The system according to claim 6, further comprising a power supply being coupled to said eyeglasses, said power supply being electrically coupled to said processor, said power supply comprising at least one battery.

9. An illuminated eyeglasses system comprising:
a pair of eyeglasses being configured to be worn, said eyeglasses including a first arm and a second arm, each of said first arm and said second arm having an outwardly facing surface, said outwardly facing surface of each of said first arm and said second arm having a recess extending inwardly therein, said recess corresponding to each of said first arm and said second arm extending substantially a full length along said associated first arm and said associated second arm;
a pair of covers, each of said covers being removably coupled to an associated one of said first arm and said second arm, each of said covers being coextensive with said recess corresponding to said first arm and said second arm, each of said covers being comprised of a translucent material;
a light emitting array being coupled to said eyeglasses wherein said light emitting array is configured to be visible on said eyeglasses, said light emitting array emitting light in a selected pattern, said light emitting array comprising:
a first set of light emitters, each of said first set of light emitters being positioned on said outwardly facing surface of said first arm, said first set of light emitters being spaced apart from each other and distributed along said recess corresponding to said first arm,
a first switch being coupled to said outwardly facing surface of said first arm, said first switch being electrically coupled to said first set of light emitters,
a second set of light emitters, each of said second set of light emitters being positioned on said outwardly facing surface of said second arm, said second set of light emitters being spaced apart from each other and distributed along said recess corresponding to said second arm,
a second switch being coupled to said outwardly facing surface of said second arm, said second switch being electrically coupled to said second set of light emitters,
a processor being coupled to said eyeglasses, said processor being electrically coupled to said first set of light emitters and said second set of light emitters, said processor actuating each of said first set of light emitters and said second set of light emitters to emit light in a selected one of a plurality of patterns,
a first transceiver being coupled to said eyeglasses, said first transceiver being electrically coupled to said processor, and
a power supply being coupled to said eyeglasses, said power supply being electrically coupled to said processor, said power supply comprising at least one battery; and
an electronic device, said electronic device including a second transceiver, said electronic device storing an actuation program, said second transceiver being in electrical communication with said first transceiver, said actuation program actuating said first set of light emitters and said second set of light emitters to emit light in the selected one of the plurality of patterns.
